(19) United States
(12) Patent Application Publication
(10) Pub. No.: US 2003/0088008 A1
(43) Pub. Date: May 8, 2003

(54) Molding composition for the transfer of micro-structured surfaces

(76) Inventor: Harald A. Kuhs, Gemmrigheim (DE)

Correspondence Address: Joe A. Powell, PolyOne Corporation, 33587 Walker Road, Avon Lake, OH, 44012, US

(21) Appl. No.: 09/975,534

(22) Filed: Oct. 11, 2001

(51) Int. Cl. C08K 3/26; C08K 3/18; C08K 3/22; C08K 3/08; C08K 3/34; C08K 3/40

(52) U.S. Cl. 524/439; 524/492; 524/494; 524/445; 524/425; 524/430

(57) ABSTRACT

The present invention relates to a composition comprising a binder and spherical inorganic matrix particles. The invention furthermore relates to a porous shaped article obtainable from said composition, a method of making said article and the use of said article as a mold or a device for conducting a fluid between a space and a duct or for deep drawing or engraving of plastic films and foils.

### TECHNICAL FIELD

The present invention relates to a composition comprising a binder and spherical inorganic matrix particles. The invention further relates to a porous shaped article obtainable from said composition, a method of making said article, a mold comprising said porous article and a device for conducting a fluid between a space and a duct or for deep-drawing or engraving of plastic films and foils.

### BACKGROUND ART

Recent developments in the molding technology have provided molds, in particular in the field of deep drawing, consisting of porous materials with enhanced surface properties and improved air permeability replacing formerly used molds consisting of a non-porous, solid mold into which were provided with holes through which the air is withdrawn by suction. This technique has been proven to be deficient when it comes to transferring finely structured or smooth surfaces to the molded deep-drawn article.

U.S. Pat. No. 6,015,518 discloses a device comprising a coarsely porous shaped part, whose surface, at the point where the fluid flows through it, carries a finely porous surface layer and on the other surface areas fluid-impermeable closing means, which are interrupted by at least one duct connection opening. At least the coarsely porous shaped part and the finely porous surface layer are in the form of a plastic body through which passes a three-dimensional network of pores, which pass in finer, but continuous manner from the shaped part into the surface layer and to the outer surface thereof. The fluid-impermeable closing means can be constructed as pore-free closing layer for the same plastic body or can be a separate part linked by suitable means with the plastic body. The coarsely porous shaped part, the finely porous surface layer and optionally the pore-free closing layer advantageously are made from the same cured plastic, in which are incorporated in the vicinity of the surface layer smaller particles, in the vicinity of the shaped part larger particles and in the vicinity of the closing layer no particles. The weight proportion of the particles in the surface layer and in the shaped part is higher than the weight proportion of the plastic and in the surface layer it is generally lower than in the shaped part. For the manufacture of the device various mixtures of particles and as yet uncured plastic are produced, said mixtures being superimposed in suitable molds, compacted (optionally individually) and cured together. Concerning the materials particularly suitable for the manufacture of the device according to '518 it is referred to European patent application publication 0486421. The material comprises a cured plastic, e.g. an epoxy-based plastic, in which are incorporated particles with a preferably irregular shape in such a way that the material has a continuous porosity in all directions. The particles are preferably of aluminium or an aluminium alloy, but can also be of another metal or a ceramic material.

U.S. Pat. No. 5,061,427 is directed to a mold body consisting of a mechanically workable, porous material, which allows providing complicated shapes without suffering a loss of quality of the deep drawn foil. The porous mold body is made by a method comprising the steps of shaping a mixture of metallic particles and resin into a uniformly porous homogeneous, unstratified block, wherein said metallic particles are of irregular shape and the size of said metallic particles is selected such that in said mixture particles of a size through the whole particle size range of 10 μm to 450 μm are provided; curing said resin; forming a shape determining gas permeable mold face surface on the unstratified block, said surface having a plurality of pores, by mechanically machining said shape determining mold face surface to a desired shape, wherein a porosity of said mold face surface remains intact during machining; and, covering a plurality of remaining surfaces of the block to make them gas impermeable.

WO publication 95/11744 describes a distributor element having a distributor body to distribute fluids as finely as possible and with low pressure loss. The distributing body is made of a material provided with pores connected to a channel system. The channel system is formed by the outer delimiting surfaces of clusters that in turn consists of particles, and connects the inlet surface with the outlet surface of the distributing body. Distributing surfaces that distribute the fluid in the distributing body before the fluid enters and flows through the distributing body are arranged in the distributing body.

U.S. Pat. No. 5,840,425 discloses a material, produced by forming clusters having a fine structure, each cluster comprising a plurality of particles of comparable size held together by a first binding agent and shaping said clusters into a cohesive structure with the aid of a second binding agent to fasten together a plurality of said clusters, thereby forming a coarser structured material, said material containing a first system of coarser structured channels and cavities extending between the clusters or being formed by the outer envelope of the clusters and a plurality of second systems of fine structured channels and cavities extending between the particles and within the clusters, said first coarse structured channel system and said second fine structured systems of channels being interconnected. According to the disclosure of the '425 patent the metal powder must have particles with a very irregular shape. The particle size is disclosed to be between 50 μm and 100 μm. Cluster formation takes place by a kneading and rubbing process, such as is carried cut by bakers with dough. The disclosed material can be used for producing shaped articles, models, filters, distributors for distributing gases or liquids, mixers for mixing gases and/or liquids, storing means, fire/noise protection coverings, etc.

The state of the art porous articles consisting of a granular material and a plastic binder material suffer from the drawback that the pores clog along the surface where it is cut due to the smudging of the binder of the plastic material, and small particles of material from the art surface disintegrate resulting in a surface which is no longer perfectly smooth.

### SUMMARY OF THE INVENTION

It has been a first object of the present invention to provide a composition which can be formed into any shape resulting in a shaped porous article.

It has been a second object of the present invention to provide a shaped article having a porous structure and which can be part of a mold or form the mold itself.

It has been a third object of the present invention to provide a method for making the shaped porous article which may find utility in, for instance, a device for conducting a fluid between a space and a duct, such as in a mold which is used as a mold for deep-drawing.

It has been a fourth and particular object of the present invention to provide a shaped article made from the composition according of the invention which has a fine and finest and, in a preferred embodiment, a micro-structured surface which shaped article can be used as a mold for deep-drawing of plastic films, foils etc. into the surface of which the structures of the mold are transferred. The solution to this object allows for the imaging of fine and finest structures (micro-structures) on deep-drawn or engraved articles at small tolerances, resulting in an exact transfer of the topographies and micro-topography from the mold surface to the molded and/or deep-drawn article.

### DETAILED DESCRIPTION OF THE INVENTION

The present invention provides:

A composition comprising

(i) a minor amount of a binder and

(ii) a major amount of spherical inorganic particles (matrix particles).

According to the present invention the binders are selected from the group consisting of organic polymers and alkali silicates. The organic polymer binders are selected from the group consisting of thermoplastic polymers and cured polymers. In particular the binders are:

(a) particulate thermoplastic polymers which are mixed with the matrix particles and which are subsequently sintered at a temperature above the melting point of the binder polymer,

(b) liquid polymer resins which are mixed with the matrix particles and which are subsequently cured by thermal or chemical curing, and

(c) aqueous solutions of sodium and/or potassium water-glasses which are mixed with the matrix particles and which are subsequently hardened by evaporation of water.

Polyetherether ketones (PEEK) are the preferred thermoplastic polymer (a). PEEK polymers having a heat distortion temperature of above 100° C., more preferably of at least about 150° C., and most preferably of at least about 175° C. are well known in the art. In general PEEK polymers possess an excellent solvent resistance and an outstanding thermal stability (PEEK-melts are stable for more than one hour at 400° C.). It may either be a homopolymer comprising repeating units or a copolymer comprising various repeating units. The phenylene groups of the said repeating units may contain lower alkyl groups, halogen groups, nitro groups, nitrile groups, amino groups, phenoxyl groups, phenyl groups and/or biphenyl groups.

The PEEK used in the present invention may be obtained by known state of the art polymerization methods. As an example there may be mentioned a method of condensation polymerising an aromatic dihalogen compound and a diphenol in the presence of an alkali salt. The said polymerization method is described in JP-B-57-22938, U.S. Pat. Nos. 4,113,699 and 4,320,224 and JP-A-54-90296. The disclosure of these references is incorporated herein by reference. The polymerization degree of PEEK used in the present invention is not particularly limited. The polymerization degree of PEEK is expressed as reduced viscosity obtained from measurements at 25° C. with an Ostwald viscometer of a 0.1 percent PEEK solution (PEEK weight/concentrated sulfuric acid volume), the solvent being concentrated sulfuric acid having a density of 1.83 g/cm³. The measurement should be performed in the vicinity of 25° C. immediately after PEEK is dissolved in order to minimize the influence of sulfonation. The viscometer of an approximately two minute solvent efflux time is used in the measurement. The reduced viscosity of PEEK used in the present invention is ordinarily in the range of 0.5 to 2.5 dl/g. In order to obtain high mechanical strength of the resulting membrane, it is preferred that the reduced viscosity is in the range of 0.8 to 2.5 dl/g.

In an alternative the thermoplastic polymers (a) can be selected from the group consisting of polyvinylchloride (PVC), polypropylene (PP), polyethylene (PE), acryinitrile-butadiene-styrene-copolymers (ABS), polycarbonates (PC), polymethylmethacrylate (PMMA) and polyvinylidenfluoride (PVDF), and thermoplastic polyolefins (TPO). Preferably these thermoplastic polymers have a heat distortion temperature as defined above.

Epoxy resins are preferred as the liquid curable synthetic resin (b). Epoxy resins are prepolymers that contain on the average two or more epoxide groups per molecule. Their reaction with a variety of curing agents leads to cross-linked or thermoset plastics with excellent strength, toughness and chemical resistance. Suitable epoxy resins are known from the prior art an commercially available. For instance, D.E.R.®, D.E.N.®, Tactix®, Quartex® supplied by Dow Chemical; Epon®, Epikote®, Eponol®, Eponex® supplied by Shell; Araldite®, Aracast® supplied by Ciba Geigy; Epi-Rz® supplied by Celanese, Epotuf® supplied by Reichold or Unox® supplied by Union Carbide, Neukadur®, Biresin® and Ebalta LM® can be used.

Important multifunctional curing agents for said epoxy resins include aliphatic and aromatic polyamines, dicarboxylic acid anhydrides, polyamide amines, aminoplasts and phenoplasts.

Further suitable liquid curable synthetic resin (b) in accordance with the present invention are polyurethane (PU) resins, alkyd resins, unsaturated polyester (UP) resins, melamine resins, polyacrylate resins, vinylester resins and phenolic resins which are obtainable from condensation reactions of phenols with aldehydes or ketones.

The aqueous alkali silicate binder (c) is selected from the group consisting of sodium-water glasses, potassium water-glasses and mixtures thereof. This binder (c), once hardened, is known for its superior thermal resistance

After mixing an aqueous solution of water glass and the matrix material the resulting premix is subsequently hardened by the evaporation of water.

According to the present invention suitable matrix particles have an average particle size within a certain predetermined range. The average particle size is referred to herein as the log-normal distribution D₅₀ median value. The D₅₀ median value is determined by using the sieve analysis procedure described in the American Society for Testing and Materials (ASTM) standard B214-92, entitled “Standard Test Method for Sieve Analysis of Granular Metal Powders” and the reporting procedure described in ASTM D1366-86 (reproved 1991), entitled “Standard Practice for Reporting Particle Size Characteristics of Pigments”. As used in this document, the matrix particles particle D₅₀ median value is determined by plotting the cumulative weight percentages versus the upper class size limits data, as shown in ASTM D-1366-86, and then determining the diameter (i.e. D₅₀) that corresponds to the fifty percent cumulative weight value.

In a preferred embodiment the matrix particles have a particle size of about 5 to about 80 μm, preferably about 5 to about 50 μm, most preferably about 25 to about 40 μm. In order to prevent clogging of the pores, at least about 80 wt.-%, preferably about 85 wt.-%, most preferably about 98 wt.-% of the matrix particles have an average particle size which does not deviate more than about 15%, preferably not more than about 10%, most preferably not more than about 5% from the average particle size.

Preferably the inorganic matrix particles are substantially free of dust having a particle size of less than about 5 μm, preferably less than about 4 μm. By “substantially free” there is meant that less than about 20 wt.-%, preferably less than about 15 wt.-% and most preferably less than about 10 wt.-% of the dust particles mentioned above are contained in the total of said matrix particles.

The inorganic matrix particles have a spherical shape, i.e., they are micro-spheres (micro-beads). A spherical shape leads to the least interaction (e.g., adhesion, friction, etc.) between the matrix particles and to the least clogging of the voids. The spherical shape of the matrix particles leads to flow-characteristics of the composition which is the basis for an excellent adaptation of fine surface structures of the master mold and renders the matrix particles capable to image the surface to be transferred.

Various matrix materials which fulfil the prerequisites in regard of shape and average particle size can be used. The material of said matrix particles is selected from the group consisting of aluminium, copper, iron, steel, titanium, platinum, manganese, zinc, bronze and other metal alloys, coal, glass, ceramic, quartz, silica, silicon carbide, tungsten carbide, boron carbide, metakaolin, calcinated clay, chinese clay, calcium carbonate, barium sulfate, aluminium oxide, and magnesium oxide. Blends of particles of different material can be used.

By a suitable selection of the matrix material the properties such as thermal and electrical conductivity, fluid permeability and/or mechanical, thermal and chemical stability of the mold material can be controlled and predetermined.

The spherical matrix material is mixed with the binder polymer which sets after processing.

In a further aspect the present invention relates to a method of making a porous shaped article comprising the steps of

mechanically mixing

(i) a minor amount of a binder, and

(ii) a major amount of spherical inorganic matrix particles,

forming the mixture into the desired shape,

and exposing it for a time and at a temperature sufficient to solidify the mixture.

In particular, said method comprises the steps of

mechanically mixing a major amount of spherical inorganic matrix particles with a minor amount of a binder selected from the group consisting of:

(a) particulate organic thermoplastic polymers,

(b) liquid organic polymer resins, and

(c) aqueous solutions of alkali silicates

forming the mixture into the desired shape, and

treating the mixture for a time and at a temperature sufficient to

in case of (a), sinter the polymer, or

in case of (b), cure the polymer, or

in case of (c), harden the mixture.

In case that a particulate thermoplastic organic polymer binder (a) is used the thermoplastic polymer binder and the spherical matrix material can be combined to form a premix with good shelf-life. Articles of various shapes, such as moldings, engraving or clamp tools can be formed from said premix. If a mold is to be formed from said premix the master mold is covered with the premix composition stamped, optionally followed by oscillating or vibrating the mixture. Subsequently the mold formed is sintered by a heat and pressure treatment and, thereafter, separated from the master mold. Concerning the particle size of the particulate thermoplastic organic binder polymer (a), the binder particles must have a particle size which is smaller or at least equal to the particle size of the spherical matrix particles.

In conjunction with the present invention the term “sintering” describes a controlled heat and pressure treatment by which the spherical matrix particles are covered with a thin layer of the molten binder polymer bonding the spherical particles together and maintaining the final shape of the shaped article.

Dependent on the nature of the polymer binder the heat treatment takes between about 0.5 h and about 30 h, preferably between about 0.5 h and about 25 h.

The processing temperatures have to be above the melting point of the thermoplastic polymer. In general the processing temperature is between about 100° C. and about 400° C., preferably between about 100° C. and about 250° C.

The applied processing pressure depends on the shape and structure of the article to be produced, in general pressures up to 470 tons/cm² (1 ton=1,000kg) can be used.

In an alternative embodiment of the present invention the treatment is carried out by gradually raising the temperature from about 20° C. to about 400° C., preferably about 20° C. to about 250° C. over a period of time between about 5 h and about 30 h, preferably about 5 h and about 20 h.

The amount of binder is to be selected so as to not clog the cavities and pores in between the matrix particles. This is necessary in order to ensure the desired porosity of the shaped article. In view of this it is necessary to use an appropriate ratio of matrix particles to polymer binder. According to the invention the weight-ratio of matrix particles to polymer binder is chosen to be from about 100:10 to about 100:0.1, preferably from about 100:8 to about 100:1.0, most preferably from about 100:8 to about 100:3.5.

In case that a liquid, curable polymer binder (b) is used, for instance an epoxy resin, the inorganic matrix particles, the epoxy-resin and an appropriate amount of curing agent for the epoxy-resin are mixed immediately before forming the mold. In general the short pot life after addition of the curing agent requires an immediate processing of the composition. In contrast to the thermoplastic binder polymers (a) the non-thermal curable epoxy resin (b) can be applied if temperature sensitive master molds shall be transferred to a mold.

To avoid clogging of the pores of the obtained porous materials the mixture of the matrix material and binder polymer (b) should form a so-called “dry mixture”. This means that after thoroughly mixing the matrix particles and the polymer, a thin layer of the binder polymer covers each individual particle of the inorganic spherical matrix material. As already mentioned above in conjunction with binder polymer (a) the amount of the curable binder polymer is selected to be sufficient to cover the surface of the spherical particulates without filling and clogging the cavities between the micro-spheres.

A “dry mixture” consists of matrix particles and a binder polymer in a weight ratio of about 100:10 to about 100:0.1, preferably in a ratio of about 100:8 to about 100:1.0, most preferably in a weight ratio of about 100:8 to about 100:3.5.

The heat and pressure treatment is carried out depending on the nature of the epoxy binder polymer. Typically, the treatment is carried out between about 0.5 h and about 30 h, preferably between about 0.5 h and about 25 h.

In addition the temperature of the treatment has to be selected depending from the epoxy binder polymer. When using a liquid chemical curing agent (b) the heat treating temperature is below the melting point of the polymer. Typically, the processing temperature is between about 20° C. and about 400° C., particularly between about 100° C. and about 250° C.

The applied processing pressure depends on the shape and structure of the article to be produced, in general pressures up to 470 tons/cm² can be used.

In an alternative embodiment of the present invention the treatment is carried out by gradually raising the temperature from about 20° C. to about 400° C., preferably about 20° C. to about 250° C. over a period of time between about 5 h and about 30 h, preferably about 5 h and about 20 h.

In case that an aqueous solution of alkali silicates, for instance, sodium and/or potassium water-glasses (c) is used, the inorganic matrix particles and the aqueous water-glass are mixed before forming the mold. In contrast to the thermoplastic polymer binder (a) and to the curable epoxy resin (b), molding tools which are manufactured by use of water-glass (c) have a superior heat stability and show heat distortion temperatures above 800° C. The molding tools comprising hardened alkali silicates as the binder can be utilized for molding of low melting metals and metal alloys.

To avoid clogging of the pores of the obtained porous materials the mixture of the matrix material and alkali silicates such as water-glass (c) should form a so-called “dry mixture”. This means that after thoroughly mixing the matrix particles and the water-glass a thin layer of the water-glass covers each individual particle of the inorganic spherical matrix material. As already mentioned above in conjunction with binder polymers (a) and (b) the amount of the alkali silicate binder is selected to be sufficient to cover the surface of the spherical particulates without filling and clogging the cavities between the micro-spheres.

A “dry mixture” consists of matrix particles and the alkali silicate in a weight ratio of about 100:10 to about 100:0.1, preferably in a ratio of about 100:8 to about 100:1.0, most preferably in a weight ratio of about 100:8 to about 100:3.5. The weight of the alkali silicate being determined on the weight of the dry alkali silicate.

The heat and pressure treatment is carried out between about 0.5 h and about 30 h, preferably between about 0.5 h and about 25 h.

The processing temperature is between about 20° C. and about 900° C., particularly between about 100° C. and about 400° C.

The applied processing pressure depends on the shape and structure of the article to be produced, in general pressures up to 470 tons/cm² can be used.

In an alternative embodiment of the present invention the treatment is carried out by gradually raising the temperature from about 20° C. to about 900° C., preferably about 20° C. to about 250° C. over a period of time between about 5 h and about 30 h, preferably about 5 h and about 20 h.

When making the porous shaped article of the invention from the above-mentioned compositions the pore-volume may additionally be influenced by a chemical foaming agent which may be used to enlarge the cavities and pores between the matrix particle spheres. Enlarging the pore-size leads to an increased fluid-permeability, such as air-permeability of the obtained porous article. Chemical foaming agents which may be used for said purpose are selected from NH₄HCO₃ and Ca(H₂PO₄)₂ in combination with traces of water. Preferably the chemical foaming agent is present in an amount of about 0.1 to about 2.0 wt.-%, most preferably of about 0.1 to about 1.0 wt.-%, based on the total amount of the composition.

The porous article, for instance, a mold has (micro-)pores evenly distributed over the surface and throughout the article. This permits the fluid to evenly flow through the entire surface of porous article. This is advantageous in that, in case of using the mold in a deep-drawing method, the film to be deep-drawn is evenly adhered to the mold surface by suction and simultaneously fixed to the entire surface allowing the contours and micro-contours (topography) of the mold-surface to transfer to/to impress on the article to be deep-drawn, such as a plastic film, without any loss of quality.

A further aspect of the present invention is directed to a porous shaped article comprising

(i) a minor amount of a binder and

(ii) a major amount of spherical inorganic matrix particles

formed from the above-described material. Said shaped article can be a mold which is made by a method comprising the steps of

mechanically mixing

(i) a minor amount of a binder, and

(ii) a major amount of spherical inorganic matrix particles,

forming the mixture into the desired shape,

and exposing it for a time and at a temperature sufficient to solidify the mixture.

In particular, the method comprises the steps of

mechanically mixing a major amount of spherical inorganic matrix particles with a minor amount of a binder selected from the group consisting of:

(a) particulate organic thermoplastic polymers,

(b) liquid organic polymer resins, and

(c) aqueous solutions of alkali silicates

forming the mixture into the desired shape, and

treating the mixture for a time and at a temperature sufficient to

in case of (a), sinter the polymer, or

in case of (b), cure the polymer, or

in case of (c), harden the mixture.

In accordance with the present invention the above-described porous shaped article can have a structured, preferably a micro-structured surface. If said porous shaped article is used as a molding tool said structure may be transferred to/impressed on a work-piece, for instance, a molded article. The surface structure of the mold is perfectly transferred to the plastic, thus achieving an extremely detailed definition to the minutest detail.

A mold having a structured surface or a finer-structured surface having a micro-topography may be formed using the composition according to the present invention by impressing thereon a structured master-mold.

According to the invention, the mold is formed from a master mold or from a negative imprint of the original workpiece, respectively. Typically, the method comprises the following steps:

i. Providing the master mold with a separating means;

ii. Laminating those parts of the mold surface which will not image the later shape-producing surface of the mold to be produced (this step may also be made at the end);

iii. Embedding of pneumatic or hydraulic conduits, inserts and similar which are to be formed directly into the porous mold into the master mold;

iv. Obtaining an optimal mixing of the mixture consisting of matrix particles and binder;

v. Filling the mixture into the master mold;

vi. Stamping and oscillating/vibrating the mixture filled layer-by-layer into the master mold;

vii. Leaving the mold inside of the master mold to set and thereafter conducting a pressure and heat treatment depending on the molding composition which has been used;

viii. Removing the master mold from the mold;

ix. Removing the separating agent by a washing or grinding and finally, an annealing for reaching an optimum hardness and/or strength;

x. Covering the outer surfaces of the mold with the exception of its structure transferring/impressing surface with a surface layer, which seals the pores. In the sealing layer opening can be provided for the connection of a duct.

In this context it shall be noted specifically that because the mold can be processed mechanically, it is possible to provide for ducts for generating positive pressure or reduced pressure in the mold also at a later stage.

Alternatively, by means of the production steps set forth above a porous form body block of arbitrary shape and surface structure can be made by machining such as drilling, milling, rotary forming and grinding, engraving, impressing or polishing, etc.

The manufacturer of the mold has various alternatives to modify or repair the tool without it suffering from quality. It is evident that by such a procedure it is possible to produce tools for molds at low costs. The molds are also suitable for the production of individual pieces such as patterns, serial tools and prototypes.

A further aspect of the present invention relates to a device for conducting a fluid between a space and a duct comprising a porous shaped, part made of the composition as described above, whose surface is porous at the point where the fluid flows through, and the other surface areas are provided with a fluid-impermeable closing means (seal), which are interrupted by at least one duct connection opening.

Again, the surface, at the point where the fluid flows through may be structured and therefore may be used to transfer/impress its topography/structure to a work-piece.

In conjunction with the present invention, said fluid may be a liquid as well as a gas. Typically, the gas is air or nitrogen.

A further embodiment of the invention is directed to a deep-drawing mold comprising a duct and a shaped porous part as described above, wherein the surface of said shaped porous part, at the point where the fluid flows through, is porous and the other surface areas are provided with a fluid-impermeable closing means, which are interrupted by at least one duct connection opening.

Lastly, in two embodiments the invention is directed to a method of deep drawing and to a method of engraving the surface of a plastic part, using a device as above. In which a surface structure from a mastermold is transferred to the device and thereof to a plastic work-piece, e.g., a plastic film, wherein the plastic film is positioned over the porous surface of the porous shaped part and air is sucked out of the cavity formed between the plastic film and the porous part by means of a suction device.

Due to the micro-topography on their surface, their finely-porous structure and their excellent fluid permeability the porous shaped article according to the invention can find utility in various technical fields:

In plastics technology mold tools with or without micro-structured surfaces can be manufactured as for instance twin sheet molds, deep-draw press molds, deep-draw molds, injection molds or embossing rolls for engraving of plastic films and foils.

In impression technology female molds for stones and castings, polymer concrete stones, sand casting molds, tiles tableware and further molded articles can be made. Said molds allow the evacuation of the entire shape-giving surface, therefore a slurry of clay or gypsum can be drained rapidly after filling into the mold.

In the manufacture of cardboard or paper the shaped articles according to the invention can be used for the deckering of pulps, for the production of press molds for cardboard/paper articles, packaging parts, support materials and containers.

In wet molding and laminating technology the shaped porous articles can be used to manufacture press molds for fiberglass or carbonfiber reinforced plastics, cellulose and textiles as well.

In die casting technology the porous shaped articles can be used as molds for high-viscous molding compounds, e.g., molded articles of silicone, seals for air conditioning, components for air conditioning, air inlets and vents, components for weak flows.

In the field of air-conditioning technology cooling modules for the dissipation of heat, e.g., of elements with high structural density can be manufactured.

Silos, containers, tanks, silo discharging auxiliary such as flow trays or ventilation domes fully or partially made of those porous materials according to the invention facilitate control of the temperature and humidity of bulk/granular materials. Additionally conveying, discharging and fluidizing of bulk materials or disintegration of the materials to be mixed on the bottom of a container is easily possible.

In chemical engineering and processing powders can be easily compressed, degassed or deaerated. Furthermore fluids and solids can be separated or purified by using the porous shaped articles according to the invention.

In mechanical applications air bearings made from the porous materials allow the transport of goods on an air film.

In clamping technology sensitive materials can be kept/adhered by suction.

The molds according to the invention may be used for forming thermoplastic objects such as films and foils, preferably plastic films and foils by deep-drawing and engraving and impressing techniques. These articles may be utilized, for instance, as dashboards, interior parts for cars, industrial products, furniture and the like. Particularly, the invention relates to transferring microstructures of surfaces, such as hair-like or leather-like structures to plastic films and foils. Herein below the present invention will be described in more detail with reference to the following examples which should not be construed to limit the scope of the present invention.

### EXAMPLES

### Example 1

| Properties of the molding | |
|---|---|
| material | |
| Binder Polymer | epoxy-Resin, curing Agent |
| Matrix particles | Copper (10 μm) |
| Matrix particles/Binder Polymer | 100:8.3 parts by weight |
| ratio | |

After 15 to 30 min of thoroughly mixing of the listed compounds using a barrel mixer a homogeneous composition was obtained. A mold has been made using the above mentioned composition.

Properties of the mold

| Colour | copper-colored | |
|---|---|---|
| Density [g/cm³] | 4.79 | DIN 16945 |
| Flexural strength [N/mm²] | 23.7 | ISO 178 |
| Flexural modulus [N/mm²] | 6960 | ISO 178 |
| Tensile strength [N/mm²] | 10.6 | ISO 527 |
| Compressive strength [N/mm²] | 54 | ISO 604 |
| Heat distortion temperature [° C.] | 189 | ISO R 75 Be |
| Shore hardness [D] | 83 | DIN 53505 |
| Electrical resistance [Ω/cm] | 0.5 | |
| Air permeability [Nm³/h] | 1.78 | ¹⁾ |
| Reduced pressure [bar] | −0.75 | |

¹⁾ The air permeability was measured by a compressed air consumption measuring device according to DIN 1952 or DIN 53887.
All measurements have been performed under standardized conditions (room temperature, atmospheric pressure).

### Example 2

| Properties of the molding | |
|---|---|
| material | |
| Binder Polymer | Polyetheretherketone (PEEK) |
| Matrix particles | Aluminumhydroxid (10 μm) |
| Matrix particles/Binder Polymer | 100:3.125 parts by weight |
| ratio | |

After 8 h of thoroughly mixing of the listed compounds using a barrel mixer a homogeneous composition was obtained. A mold has been made using the above-mentioned composition.

Properties of the mold

| Colour | White | |
|---|---|---|
| Density [g/cm³] | 2.2 | DIN 16945 |
| Flexural strength [N/mm²] | 48.7 | ISO 178 |
| Flexural modulus [N/mm²] | 12800 | ISO 178 |
| Impact strength [KJ/m²] | 3.4 | ISO 179 |
| Tensile strength [N/mm²] | 20.8 | ISO 527 |
| Compressive strength [N/mm²] | 74 | ISO 604 |
| Heat distortion temperature [° C.] | 340 | ISO R 75 Be |
| Shore hardness [D] | 87 | DIN 53505 |
| Air permeability [Nm³/h] | 1.75 | ¹⁾ |
| Reduced pressure [bar] | −0.9 | |

¹⁾ The air permeability was measured by a compressed air consumption measuring device according to DIN 1952 or DIN 53887.
All measurements have been performed under standardized conditions (room temperature, atmospheric pressure).

All measurements have been performed under standardized conditions (room temperature, atmospheric pressure).

### Example 3

| Properties of the molding | |
|---|---|
| material | |
| Binder Polymer | Sodium water-glass |
| Matrix particles | Quartz (5-10 μm) |
| Matrix particles/Binder Polymer | 100:0.25 parts by weight |
| ratio | |

After 15 to 30 min of thoroughly mixing of the listed compounds using a barrel mixer a homogeneous composition was obtained. A mold has been made using the above-mentioned composition.

Properties of the mold

| Colour | Grey | |
|---|---|---|
| Density [g/cm³] | 2.5 | DIN 16945 |
| Flexural strength [N/mm²] | 23.7 | ISO 178 |
| Flexural modulus [N/mm²] | 24580 | ISO 178 |
| Impact strength [KJ/m²] | 2.4 | ISO 179 |
| Tensile strength [N/mm²] | 15.3 | ISO 527 |
| Compressive strength [N/mm²] | 84 | ISO 604 |
| Heat distortion temperature [° C.] | 900 | ISO R 75 Be |
| Rockwell hardness [HRA] | 87 | DIN 53505 |
| Air permeability [Nm³/h] | 1.88 | ¹⁾ |
| Reduced pressure [bar] | −0.72 | |

¹⁾ The air permeability was measured by a compressed air consumption measuring device according to DIN 1952 or DIN 53887. All measurements have been performed under standardized conditions (room temperature, atmospheric pressure).

The foregoing description has been directed to particular embodiments of the invention in accordance with requirements of the Patent Statutes for the purposes of illustration and explanation. It will be apparent, however, to those skilled in the art, that many modifications, changes and variations in the claims embodiments will be possible without departing from the scope and spirit of the claimed invention. It is intended that the following claims be interpreted to embrace all such modifications and changes.

What is claimed is:

1. A composition comprising
(i) a minor amount of a binder and
(ii) a major amount of spherical inorganic matrix particles.

2. The composition of claim 1 comprising the inorganic particles and the binder in a weight ratio of about 100:10 to about 100:0.1.

3. The composition of claim 1 comprising the inorganic matrix particles and the binder in a weight ratio of about 100:8 to about 100:1.0.

4. The composition of claim 1 comprising the inorganic matrix particles and the binder in a weight ratio of about 100:8 to about 100:3.5.

5. The composition of claim 1 wherein the binder is selected from the group consisting of organic polymers and alkali silicates.

6. The composition of claim 5 wherein the organic polymer binder is selected from the group consisting of thermoplastic polymers.

7. The composition of claim 5 wherein the organic polymer binder is selected from the group consisting of cured polymer.

8. The composition of claim 5 wherein the alkali silicate is selected from the group consisting of sodium-water glasses, potassium-water glasses and mixtures thereof.

9. The composition of claim 6 wherein the thermoplastic organic binder polymer is selected from the group consisting of polyether-ether-ketones (PEEK), polyvinylchloride (PVC), polypropylene (PP), polyethylene (PE), acrylnitrile-butadiene-styrene-copolymers (ABS), polycarbonates (PC), poly-methylmethacrylate (PMMA), polyvinylidenfluoride (PVDF) and thermoplastic polyolefins (TPO).

10. The composition of claim 7 wherein the cured polymer is selected from the group consisting of epoxy resins, polyurethane (PU) resins, alkyd resins, unsaturated polyester (UP) resins, melamine resins, vinylester resins, acrylate resins and phenolic resins.

11. The composition of claim 1 wherein the inorganic spherical matrix particles are made of a material selected from the group consisting of aluminium, copper, iron, steel, titanium, platinum, manganese, zinc, bronze and other metal alloys, coal, glass, ceramic, quartz, silica, silicon carbide, tungsten carbide, boron carbide, metakaolin, calcinated clay, chinese clay, calcium carbonate, barium sulfate, aluminium oxide, and magnesium oxide.

12. The composition of claim 1 wherein the spherical inorganic matrix particles have a mean particle diameter of from about 5 to about 80 μm.

13. The composition of claim 1 wherein the spherical inorganic matrix particles have a mean particle diameter of from about 10 to less than about 50 μm.

14. The composition of claim 1 wherein the spherical inorganic matrix particles have a mean particle diameter of from about 25 to about 40 μm.

15. The composition of claim 1 wherein at least about 80 wt-% of the spherical inorganic matrix particles have a particle size which does not deviate more than about 15% from the average particle size.

16. The composition of claim 1 wherein at least about 85 wt-% of the spherical inorganic matrix particles have a particle size which does not deviate more than about 15% from the average particle size.

17. The composition of claim 1 wherein at least about 98 wt-% of the spherical inorganic matrix particles have a particle size which does not deviate more than about 15% from the average particle size.

18. The composition of claim 1 further comprising a chemical foaming agent.

19. The composition of claim 18 wherein the chemical foaming agent is selected from the group consisting of NH₄HCO₃ and Ca(H₂PO₄)₂.

20. The composition of claim 18 wherein the chemical foaming agent is present in an amount of from about 0.1 to about 2% by weight, based on the total amount of the composition.

21. The composition of claim 18 wherein the chemical foaming agent is present in an amount of from about 0.1 to about 1% by weight, based on the total amount of the composition.

22. A porous shaped article comprising
(i) a minor amount of a binder and
(ii) a major amount of spherical inorganic matrix particles.

23. The porous shaped article of claim 22 having a structured surface.

24. The porous shaped article of claim 22 being a mold.

25. The porous shaped article of claim 22 comprising the inorganic particles and the binder in a weight ratio of about 100:10 to about 100:0.1.

26. The porous shaped article of claim 22 comprising the inorganic matrix particles and the binder in a weight ratio of about 100:8 to about 100:1.0.

27. The porous shaped article of claim 22 comprising the inorganic matrix particles and the binder in a weight ratio of about 100:8 to about 100:3.5.

28. The porous shaped article of claim 22 wherein the binder is selected from the group consisting of organic polymers and alkali silicates.

29. The porous shaped article of claim 22 wherein the binder is an organic polymer and is selected from the group consisting of thermoplastic polymers.

30. The porous shaped article of claim 22 wherein the binder is selected from the group consisting of cured polymers.

31. The porous shaped article of claim 28 wherein the alkali silicate is selected from the group consisting of sodium-water glasses, potassium-water glasses and mixtures thereof.

32. The porous shaped article of claim 28 wherein the thermoplastic organic binder is a thermoplastic organic polymer and is selected from the group consisting of polyether-ether-ketones (PEEK), polyvinylchloride (PVC), polypropylene (PP), polyethylene (PE), acrylnitrile-butadiene-styrene-copolymers (ABS), polycarbonates (PC), polymethylmethacrylate (PMMA), polyvinylidenfluoride (PVDF) and thermoplastic polyolefins (TPO).

33. The porous shaped article of claim 30 wherein the cured polymer is selected from the group consisting of epoxy resins, polyurethane (PU) resins, alkyd resins, unsaturated polyester (UP) resins, melamine resins, vinylester resins and acrylate resins and phenolic resins.

34. The porous shaped article of claim 22 wherein the inorganic spherical matrix particles are made of a material selected from the group consisting of aluminium, copper, iron, steel, titanium, platinum, manganese, zinc, bronze and other metal alloys, coal, glass, ceramic, quartz, silica, silicon carbide, tungsten carbide, boron carbide, metakaolin, calcinated clay, chinese clay, calcium carbonate, barium sulfate, aluminium oxide, and magnesium oxide.

35. The porous shaped article of claim 22 wherein the spherical inorganic matrix particles have a mean particle diameter of from about 5 to about 80 μm.

36. The porous shaped article of claim 22 wherein the spherical inorganic matrix particles have a mean particle diameter of from about 10 to less than about 50 μm.

37. The porous shaped article of claim 22 wherein the spherical inorganic matrix particles have a mean particle diameter of from about 25 to about 40 μm.

38. The porous shaped article of claim 22 wherein at least about 80 wt-% of the spherical inorganic matrix particles have a particle size which does not deviate more than about 15% from the average particle size.

39. The porous shaped article of claim 22 wherein at least about 85 wt-% of the spherical inorganic matrix particles have a particle size which does not deviate more than about 15% from the average particle size.

40. The porous shaped article of claim 22 wherein at least about 98 wt-⁰/o of the spherical inorganic matrix particles have a particle size which does not deviate more than about 15% from the average particle size.

41. The porous shaped article of claim 22 made from a mixture which further comprises a chemical foaming agent.

42. The porous shaped article of claim 41 wherein the chemical foaming agent is selected from the group consisting of NH₄HCO₃ and Ca(H₂PO₄)₂.

43. The porous shaped article of claim 41 wherein the chemical foaming agent is present in an amount of from about 0.1 to about 2% by weight, based on the total amount of the composition.

44. The porous shaped article of claim 41 wherein the chemical foaming agent is present in an amount of from about 0.1 to about 1% by weight, based on the total amount of the composition.

45. A method of making a porous shaped article comprising the steps of
mechanically mixing
(i) a minor amount of a binder, and
(ii) a major amount of spherical inorganic matrix particles,
forming the mixture into the desired shape,
and exposing it for a time and at a temperature sufficient to solidify the mixture.

46. The method of claim 45 comprising the steps of
mechanically mixing a major amount of spherical inorganic matrix particles with a minor amount of a binder selected from the group consisting of
(a) particulate organic thermoplastic polymers,
(b) liquid organic polymer resins, and
(c) aqueous solutions of alkali silicates
forming the mixture into the desired shape, and
treating the mixture for a time and at a temperature sufficient to
in case of (a), sinter the polymer, or
in case of (b), cure the polymer, or
in case of (c), harden the mixture.

47. The method of claim 45, wherein the mixture is formed into a mold.

48. The method of claim 45 wherein the mold has a structured surface obtainable by impressing a structured mastermold.

49. The method of claim 46 wherein the treating time is between about 0.5 h and about 30 h.

50. The method of claim 49 wherein the treating time is between about 0.5 h and about 25 h.

51. The method of claim 46 wherein the treating temperature is from between about 20° C. and about 400° C.

52. The method of claim 51 wherein the treating temperature is from between about 100° C. and about 250° C.

53. The method of claim 46 wherein the mixture is treated by gradually raising the temperature from about 20° C. to about 400° C. over a period of time from between about 5 h and about 30 h.

54. The method of claim 53 wherein the mixture is treated by gradually raising the temperature from about 20° C. to about 250° C. over a period of time from between about 5 h and about 20 h.

55. The method of claim 45 wherein the mixture comprises the inorganic particles and the binder in a weight ratio of about 100:10 to about 100:0.1.

56. The method of claim 45 wherein the mixture comprises the inorganic matrix particles and the binder in a weight ratio of about 100:8 to about 100:1.0.

57. The method of claim 45 wherein the mixture comprises the inorganic matrix particles and the binder in a weight ratio of about 100:8 to about 100:3.5.

58. The method of claim 45 wherein the mixture comprises a binder selected from the group consisting of organic polymers and alkali silicates.

59. The method of claim 58 wherein the organic polymer binder is selected from the group consisting of thermoplastic polymers.

60. The method of claim 58 wherein the organic polymer binder is selected from the group consisting of cured polymer.

61. The method of claim 58 wherein the alkali silicate is selected from the group consisting of sodium-water glasses, potssium-water glasses and mixtures thereof.

62. The method of claim 59 wherein the thermoplastic organic binder polymer is selected from the group consisting of polyether-ether-ketones (PEEK), polyvinylchloride (PVC), polypropylene (PP), polyethylene (PE), acryinitrile-butadiene-styrene-copolymers (ABS), polycarbonates (PC), poly-methylmethacrylate (PMMA), polyvinylidenfluoride (PVDF) and thermoplastic polyolefins (TPO).

63. The method of claim 60 wherein the cured polymer is selected from the group consisting of epoxy resins, polyurethane (PU) resins, alkyd resins, unsaturated polyester (UP) resins, melamine resins, vinylester resins, acrylate resins and phenolic resins.

64. The method of claim 45 wherein the inorganic spherical matrix particles are made of a material selected from the group consisting of aluminium, copper, iron, steel, titanium, platinum, manganese, zinc, bronze and other metal alloys, coal, glass, ceramic, quartz, silica, silicon carbide, tungsten carbide, boron carbide, metakaolin, calcinated clay, chinese clay, calcium carbonate, barium sulfate, aluminium oxide, and magnesium oxide.

65. The method of claim 45 wherein the spherical inorganic matrix particles have a mean particle diameter of from about 5 to about 80 μm.

66. The method of claim 45 wherein the spherical inorganic matrix particles have a mean particle diameter of from about 10 to less than about 50 μm.

67. The method of claim 45 wherein the spherical inorganic matrix particles have a mean particle diameter of from about 25 to about 40 μm.

68. The method of claim 45 wherein at least about 80 wt-% of the spherical inorganic matrix particles have a particle size which does not deviate more than about 15% from the average particle size.

69. The method of claim 45 wherein at least about 85 wt-% of the spherical inorganic matrix particles have a particle size which does not deviate more than about 15% from the average particle size.

70. The method of claim 45 wherein at least about 98 wt-% of the spherical inorganic matrix particles have a particle size which does not deviate more than about 15% from the average particle size.

71. The method of claim 45 wherein the mixture further comprises a chemical foaming agent.

72. The method of claim 71wherein the chemical foaming agent is selected from the group consisting of NH₄HCO₃ and Ca(H₂PO₄)₂.

73. The composition of claim 71 wherein the chemical foaming agent is present in an amount of from about 0.1 to about 2% by weight, based on the total amount of the composition.

74. The composition of claim 71 wherein the chemical foaming agent is present in an amount of from about 0.1 to about 1% by weight, based on the total amount of the composition.

75. A device for conducting a fluid between a space and a duct comprising a porous shaped part comprising
(i) a minor amount of a binder and
(ii) a major amount of spherical inorganic matrix particles
whose surface is porous, at the point where the fluid flows through, and the other surface areas are provided with a fluid-impermeable closing means, which are interrupted by at least one duct connection opening.

76. The device of claim 75 wherein the surface, at the point where the fluid flows through, is structured.

77. The device of claim 75 wherein the porous shaped part is in a form suitable for deep-drawing.

78. The device of claim 75 comprising the inorganic particles and the binder in a weight ratio of about 100:10 to about 100:0.1.

79. The device of claim 75 comprising the inorganic matrix particles and the binder in a weight ratio of about 100:8 to about 100:1.0.

80. The device of claim 75 comprising the inorganic matrix particles and the binder in a weight ratio of about 100:8 to about 100:3.5.

81. The device of claim 75 wherein the binder is selected from the group consisting of organic polymers and alkali silicates.

82. The device of claim 81 wherein the organic polymer binder is selected from the group consisting of thermoplastic polymers.

83. The device of claim 81 wherein the organic polymer binder is selected from the group consisting of cured polymer.

84. The device of claim 81 wherein the alkali silicate is selected from the group consisting of sodium-water glasses, potassium-water glasses and mixtures thereof.

85. The device of claim 82 wherein the thermoplastic organic binder polymer is selected from the group consisting of polyether-ether-ketones (PEEK), polyvinylchloride (PVC), polypropylene (PP), polyethylene (PE), acrylnitrile-butadiene-styrene-copolymers (ABS), polycarbonates (PC), poly-methylmethacrylate (PMMA), polyvinylidenfluoride (PVDF) and thermoplastic polyolefins (TPO).

86. The device of claim 83 wherein the cured polymer is selected from the group consisting of epoxy resins, polyurethane (PU) resins, alkyd resins, unsaturated polyester (UP) resins, melamine resins, vinylester resins, acrylate resins and phenolic resins.

87. The device of claim 75 wherein the inorganic spherical matrix particles are made of a material selected from the group consisting of aluminium, copper, iron, steel, titanium, platinum, manganese, zinc, bronze and other metal alloys, coal, glass, ceramic, quartz, silica, silicon carbide, tungsten carbide, boron carbide, metakaolin, calcinated clay, chinese clay, calcium carbonate, barium sulfate, aluminium oxide, and magnesium oxide.

88. The device of claim 75 wherein the spherical inorganic matrix particles have a mean particle diameter of from about 5 to about 80 μm.

89. The device of claim 75 wherein the spherical inorganic matrix particles have a mean particle diameter of from about 10 to less than about 50 μm.

90. The device of claim 75 wherein the spherical inorganic matrix particles have a mean particle diameter of about 25 to about 40 μm.

91. The device of claim 75 wherein at least about 80 wt-% of the spherical inorganic matrix particles have a particle size which does not deviate more than about 15% from the average particle size.

92. The device of claim 75 wherein at least about 85 wt-% of the spherical inorganic matrix particles have a particle size which does not deviate more than about 15% from the average particle size.

93. The device of claim 75 wherein at least about 98 wt-% of the spherical inorganic matrix particles have a particle size which does not deviate more than about 15% from the average particle size.

94. The device of claim 75 made from a mixture which further comprises a chemical foaming agent.

95. The device of claim 94 wherein the chemical foaming agent is selected from the group consisting of NH₄HCO₃ and Ca(H₂PO₄)₂.

96. The device of claim 94 made from a mixture wherein the chemical foaming agent is present in an amount of from about 0.1 to about 2% by weight, based on the total amount of the composition.

97. The device of claim 94 made from a mixture wherein the chemical foaming agent is present in an amount of from about 0.1 to about 1% by weight, based on the total amount of the composition.

98. A deep-drawing mold comprising a duct and a shaped porous part comprising
(i) a minor amount of a binder and
(ii) a major amount of spherical inorganic particles,
the surface of which, at the point where the fluid flows through, carries a finely porous surface and on the other surface areas a fluid-impermeable closing means, which are interrupted by at least one duct connection opening.

99. The deep-drawing mold of claim 98 wherein the surface, at the point where the fluid flows through, is structured.
